(19) United States
(12) Patent Application Publication
(10) Pub. No.: US 2017/0195951 A1
(43) Pub. Date: Jul. 6, 2017

(54) METHOD FOR INTEGRATING AN INVERTER INTO A WIRELESS LOCAL AREA COMMUNICATION NETWORK, AND INVERTER SUITABLE THEREFORE

(71) Applicant: SMA Solar Technology AG, Niestetal (DE)

(72) Inventors: Markus Klein, Kassel (DE); Thomas Wappler, Niesetal (DE)

(21) Appl. No.: 15/467,225

(22) Filed: Mar. 23, 2017

Related U.S. Application Data
(63) Continuation of application No. PCT/EP2015/069896, filed on Sep. 1, 2015.

(30) Foreign Application Priority Data
Sep. 24, 2014 (DE) 10 2014 113 795.7

(51) Int. Cl. H04W 48/20; G05B 15/02

(52) U.S. Cl. CPC H04W 48/20; G05B 15/02; H04W 84/12

(57) ABSTRACT

To integrate an inverter into a wireless local area communication network, wherein the inverter is connectable by its input to a local energy source and by its output to an AC mains, the inverter and a network access point of the wireless local area communication network are taken for a limited time period to an integration state in which the inverter joins the wireless local area communication network, wherein network access data pertaining to the wireless local area communication network are stored in a memory associated with the inverter, which network access data are used by said inverter to incorporate itself into the wireless local area communication network in future. In this case, the inverter is taken to its integration state by virtue of the mains voltage of the AC mains being applied to its output for the first time or again following an interruption.

### CROSS REFERENCE TO RELATED APPLICATIONS

This application claims priority to International Patent Application number PCT/EP2015/069896, filed on Sep. 1, 2015, which claims priority to German Patent Application number 10 2014 113 795.7, filed on Sep. 24, 2014, and is hereby incorporated by reference in its entirety.

### FIELD

The disclosure relates to a method for integrating an inverter, the input side of which is connectable to a local energy source, into a wireless local area communication network. In addition, the disclosure relates to an inverter, the input side of which is connectable to a local energy source.

The local energy source to which the input side of the inverter is connectable may be, by way of example, a photovoltaic generator, a wind turbine, a battery, a fuel cell or a cogeneration unit. In particular, it is a photovoltaic generator. The inverter is then also referred to as a photovoltaic (PV) inverter.

### BACKGROUND

For reasons of cost, but also for reasons pertaining to the avoidance of unauthorized manipulation, PV inverters are in some cases produced without a dedicated display and without dedicated input apparatuses, for example. DE 10 2012 101 916 A1 discloses a method to allow, by way of example, a smartphone to be used to still display the operating parameters of a PV inverter and to allow the smartphone to be used to communicate with the controller of the PV inverter via a wireless link, in particular a Bluetooth link. To this end, a camera of the smartphone is used to record and process an image of the PV inverter in order to extract a device identification code from the PV inverter. Based on the device identification code, the smartphone sets up the wireless data link to the PV inverter. Using this method requires visual contact between the smartphone and the inverter. The data link based on the Bluetooth standard is also just one for short range.

DE 10 2013 101 985 A1 discloses a method for executing instructions on a PV inverter that has no dedicated input apparatus. To this end, a mobile device, for example a smartphone, is used to produce a data packet that contains an identification code explicitly associated with the PV inverter, a request instruction for execution by the PV inverter and an access authorization code that is associated with access rights of a user of the mobile device. The data packet is transmitted to a control center via a data communication link. Assuming that the access authorization code authorizes the user to execute the request instruction on the PV inverter, an execution instruction for executing the request instruction is produced and is transmitted to the PV inverter for execution. This transmission can take place wirelessly in the first step from the control center to the mobile device and in the second step from the mobile device on to the PV inverter, for example by means of a flashing display on the mobile device, which is detected by a photosensor of the PV inverter. The connection between the mobile device and the PV inverter can also be set up by means of near field communication (NFC). In any case, the mobile device, such as the smartphone, for example, needs to be brought into direct proximity to the PV inverter in this case too.

It would be fundamentally desirable for inverters whose input side is connectable to a local energy source to be integrated, for the purpose of displaying their operating data and accessing their control, into a wireless local area communication network that is frequently already in place for other reasons. As such, many operators of PV inverters on the roofs of residential and office buildings operate a wireless local area communication network, for example a WLAN network, in the same building.

The integration of a new component into a wireless local area communication network, particularly one protected by encryption, for example based on the Wi-Fi protected setup (WPS) standard, can be effected e.g. on the basis of a PIN input in which a PIN of the component to be integrated is input at a network access point. This may be difficult in practice if the PIN is not easily accessible, because the component on which the PIN is recorded is itself not easily accessible, or because a multiplicity of components need to be integrated into the wireless local area communication network. Regardless of this, a fixed PIN has, in principle, a certain associated security risk, since it is always ascertainable even by unauthorized third parties using a—although large—finite number of attempts. Therefore, specifically newer devices often dispense with the method of integration in line with WPS PIN input. In addition it is possible to bring about the integration of a component on the basis of a pushbutton configuration (PBC). To this end, the network access point and the component to be incorporated into the wireless local area communication network have a physical or software-implemented button for connection setup. When said button is pressed, a two-minute phase begins in which the component can join the wireless local area communication network. An inverter without a dedicated input apparatus has no physical button in place and, even if one is in place, is not readily operable, just like a software-implemented button.

WO 2011/070129 A1 discloses a method for expanding a wireless local area communication network between subscribers using an assimilation step. The subscribers are physically distributed PV inverters each having limited physical range for wireless communication. In the assimilation step, which is performed for limited time and in which predefined PV inverters take part, at least one network ID is produced and is permanently stored in each PV inverter. After the assimilation step, each PV inverter connects only to the other PV inverters that have taken part in the same assimilation step. By way of example, the assimilation step can be started by virtue of a specific PV inverter, which is provided as a node of the desired wireless local area communication network, being started for the first time. The assimilation step runs only for a defined time period. This can be extended whenever a new predefined PV inverter joins the assimilation step.

DE 10 2011 122 359 A1 discloses a circuit arrangement having an inverter and a method for checking the operation of electromechanical switches. The link circuit of the inverter is connectable to a DC voltage source, which is a photovoltaic generator as a local energy source. The inverter has a three-phase switching bridge, the output-side phase conductors of which are connectable to the phases of a three-phase AC mains. Each phase conductor is routed via a series connection comprising two switching contacts that belong to different electromagnetic switches actuatable by a control apparatus. When the inverter is switched on and/or switched off, the control apparatus actuates the electromagnetic switches alternately and detects the voltages on the phase conductors by means of measuring apparatuses. In this way, a function check takes place; only if the latter has been rated successfully the clocking of semiconductor switches in the switching bridge of the inverter is enabled.

US 2012/0161523 A1 discloses a photovoltaic installation in which an inverter is connected to a photovoltaic generator as a local energy source. The inverter may be positioned at a location that is difficult to access, e.g. under the roof, which is why the inverter is controlled by means of a wireless local area communication network, with information being interchanged via this wireless local area communication network.

### SUMMARY

The method according to the disclosure for integrating an inverter into a wireless local area communication network is disclosed. The inverter is connectable by its input to a local energy source and by its output to an AC mains, and the method involves the inverter and a network access point of the wireless local area communication network being taken for a limited time period to an integration state in which the inverter joins the wireless local area communication network, wherein network access data pertaining to the wireless local area communication network are stored in a memory associated with the inverter. The network access data are used by the inverter to incorporate itself into the wireless local area communication network in the future. In order to take the inverter to its integration state despite a lack of accessibility and/or dedicated input apparatuses, this is accomplished by applying the mains voltage at the AC mains to its output. In other words, when the mains voltage of the AC mains is applied to the output of the inverter, a virtual button is pushed that moves it to its integration state. It is understood in this case that carrying out the method according to the disclosure presupposes appropriate setup of the inverter. The inverter needs to be able to interpret the appearance of the mains voltage of the AC mains at its output as an instruction to change to its integration state.

The method according to the disclosure can involve the network access point being moved to its integration state in any desired manner, i.e. particularly by virtue of a physical button being pushed or by virtue of a software-implemented button being operated. The pushing of the physical button or the operation of the software-implemented button at the network access point starts during this one predefined algorithm, for example execution of a piece of software that is stored in the network access point and that moves the network access point to its integration state. Comparable operation of a button implemented by standard software on the inverter is discarded, on the other hand, because the inverter, prior to its integration in the wireless local area communication network, is not yet accessible for software access operations, particularly for access operations that cause a predefined piece of software stored in the inverter to be started and hence also move the inverter to its integration state. Specifically, the mains voltage of the AC mains can be applied to the output of the inverter such that a connector on power supply lines that are connected to the output of the inverter is connected to a connector leading to the AC mains. Alternatively, a switch in the power supply lines that is used to connect the inverter to the AC mains, for example even a circuit breaker or fuse switch provided in the power supply lines, can be closed.

Applying the mains voltage of the AC mains to the output of the inverter, which takes place in the method according to the disclosure in order to take the inverter to its integration state, means particularly applying the mains voltage to the output for the first time after installation of the inverter. Further application of the mains voltage to the output after the inverter has already joined the wireless local area communication network when the mains voltage was applied for the first time and network access data pertaining to the wireless local area communication network have been stored in the inverter should, by contrast, not always lead to the inverter being taken to its integration state again. Instead, this is normally even undesirable, because otherwise any brief failure in the AC mains would result in the inverter being taken to its integration state again and attempting to join a wireless local area communication network. Within the context of the disclosure, it is therefore possible in one embodiment for the inverter to be taken to its integration state precisely, i.e. only, when the mains voltage of the AC mains is applied to its output for the first time. In this case, further application of the mains voltage to the output of the inverter after its output has been isolated from the AC mains beforehand would distinctly no longer result in the inverter being taken to its integration state again.

Fundamentally, however, in another embodiment the inverter can be taken to its integration state every time the mains voltage of the AC mains is applied to its output, regardless of whether the mains voltage is applied to its output for the first time or whether the mains voltage is applied to its output after its output has been isolated from the AC mains beforehand. To avoid any mains failure of the AC mains in this case resulting in the inverter subsequently no longer being able to incorporate itself into the wireless local area communication network because, once taken to its integration state, it has unsuccessfully attempted to join the wireless local area communication network without the network access point also having been in its integration state, but has already erased its old access data, erasure of the old access data can be deferred until the inverter has joined the wireless local area communication network in its integration state again and has acquired new access data.

In another embodiment, a way of preventing the inverter from entering its integration state unintentionally as a result of mains failures and, in so doing, possibly losing still valid network access data is to take the inverter to its integration state only when the mains voltage of the AC mains is applied to its output after its output has been isolated from the AC mains for a prescribed time period beforehand. The prescribed time period can be prescribed within very narrow limits, the interval of which is just a few seconds, for example, so that mains failures have only a very low probability of resulting in isolation of the output of the inverter from the AC mains for this very time period.

If the inverter has, at its output, two connections for a neutral conductor and a phase conductor of the AC mains, between which the mains voltage is applied, and is able to record the association of the neutral conductor and the phase conductor with the individual connections, then the inverter can be selectively taken to its integration state when the mains voltage between the neutral conductor and the phase conductor of the AC mains is applied to the two connections with a different association than there was beforehand. A mains failure does not change this association. Rather, the association needs to be deliberately changed by transposing the neutral conductor with the phase conductor. This can be accomplished by a toggle switch in the power supply lines or by reconnecting connectors, that is to say does not have to involve particular complexity. However, this embodiment of the method according to the disclosure requires not only that the inverter is tolerant of the association between the neutral conductor and the phase conductor and the two connections of its output, it must also record the different associations and be able to interpret a change in the association as a signal for its change to its integration state.

A further way of preventing undesirable transfer of the inverter to its integration state is for the inverter to be selectively taken to its integration state when the mains voltage of the AC mains is applied to its output, provided that it did not yet have a connection to the network access point in the current configuration thereof. This is normally synonymous with the inverter no longer being able to use the access data stored in it to incorporate itself into the wireless local area communication network. This embodiment of the method according to the disclosure also allows an inverter from one wireless local area communication network into which it has initially incorporated itself to be integrated into another wireless local area communication network. To this end, it is sufficient for the wireless local area communication network into which it has initially incorporated itself to be temporarily shut down and then for the inverter to be transferred to its integration state by initially isolating the AC mains from and subsequently reconnecting the AC mains to the output of the inverter. Because this wireless local area communication network is not there at that moment, the inverter is then no longer able to incorporate itself into the previous wireless local area communication network. The inverter therefore, from its integration state, joins the only active wireless local area communication network at the time, which then is the other wireless local area communication network, the network access point of which likewise needs to be promptly taken to its integration state for this purpose.

Fundamentally, the method according to the disclosure can also be combined with other safety measures for limiting the wireless local area communication network. For example it may be necessary for there to be an identification associated with the inverter, such as a PIN, for example, in the network access point so that the inverter is admitted to the wireless local area communication network. This, however, increases the complexity for performing the method according to the disclosure, in one embodiment.

If the method according to the disclosure is applied to a plurality of inverters that need to be integrated into the same wireless local area communication network, then the integration can advantageously be performed separately for each of the inverters, i.e. for all inverters in succession, in order to avoid collisions between the individual integrations.

The wireless local area communication network may be a communication network based on a WLAN standard—particularly a WLAN standard based on the IEEE 802.11 family of standards. The integration state of the inverter that is achieved by applying the mains voltage of the AC mains can more particularly be a PBC configuration based on the WPS standard.

According to the disclosure, an inverter has an input for connection to a local energy source, an output for connection to an AC mains, and a communication interface for communication in a wireless local area communication network. The communication interface can be taken for a limited time period to an integration state in which it joins the wireless local area communication network via a network access point, which is likewise in the integration state, of the wireless local area communication network. The network access data pertaining to the wireless local area communication network, which are used by the communication interface to incorporate itself into the wireless local area communication network in the future, are stored in a memory associated with the inverter. The communication interface is set up to carry out the method according to the disclosure.

When the communication interface is incorporated into the wireless local area communication network, it can use the wireless local area communication network to allow bidirectional communication with a controller of the inverter—for example using a piece of software suitable for controlling the inverter, which is installed on a personal computer (PC) that is associated with or has joined the wireless local area communication network too. As such, up-to-date operating parameters can be requested from the controller, and action can be taken in the control of the inverter.

The communication interface may be the exclusive interface for communication with the inverter externally. That is to say that the inverter then has no dedicated input apparatus and normally also no dedicated display apparatus.

The inverter may be one that supplies power to itself, including its communication interface, from the local energy source connected to it, that is to say that is not reliant on the presence of the mains voltage of the AC mains for its own supply of power. It is then able to react to the presence of the mains voltage directly. If the inverter supplies itself with power from the mains voltage, on the other hand, then application of the mains voltage initially requires it to start up before it can change to its integration state. This is true even when an inverter that normally supplies itself with power from the local energy source and resorts to the mains voltage only as an alternative needs to be integrated into the wireless local area communication network before it is connected to the local energy source or at night time. The time delay between the mains voltage being applied and the integration state of the inverter being reached can be taken into consideration by delayed transfer of the network access point to the integration state thereof, however. As such, it is possible, by way of example, for the relevant switch of the network access point to be operated only after the mains voltage is applied to the inverter and in one embodiment at the time at which the inverter has been or should be started up after the mains voltage is applied.

In particular, the inverter according to the disclosure may be what is known as a micro-inverter that is arranged close to or directly on a module of the local energy source. If the local energy source is a photovoltaic generator, then a micro-inverter is arranged directly on or close to a single photovoltaic module and therefore, as a rule, is directly accessible only with great complexity, if at all.

Advantageous developments of the disclosure will emerge from the patent claims, the description and the drawings. The advantages, cited in the description, of features and of combinations of multiple features are merely exemplary and can take effect alternatively or cumulatively without the advantages necessarily having to be attained by embodiments according to the disclosure. Without this altering the subject matter of the attached patent claims, the following applies in respect of the disclosure content of the original application documents and the patent: further features are evident from the drawings. The combination of features of different embodiments of the disclosure or of features of different patent claims is likewise possible as a departure from the selected back-references of the patent claims, and is encouraged hereby. This also relates to such features as are depicted in separate drawings or are cited in the description thereof. These features can also be combined with features of different patent claims. Similarly, features listed in the patent claims can be dispensed with for further embodiments of the disclosure.

The features mentioned in the patent claims and the description should be understood, with regard to their number, such that exactly this number or a greater number than the number mentioned is present, without the need for explicit use of the adverb “at least”. Therefore, if an element is mentioned, for example, this should be understood to mean that exactly one element, two elements or more elements are present. These features can be supplemented by other features or the sole features of which the respective product consists.

The reference symbols contained in the patent claims do not restrict the scope of the subjects protected by the patent claims. They merely serve the purpose of making the patent claims more easily understood.

### BRIEF DESCRIPTION OF THE DRAWINGS

The disclosure is explained and described to a further degree below on the basis of preferred exemplary embodiments that are depicted in the figures.

FIG. 1 outlines a micro-inverter according to the disclosure incorporated into a wireless local area communication network; and

FIG. 2 is a flowchart for an embodiment of the method according to the disclosure.

### DETAILED DESCRIPTION

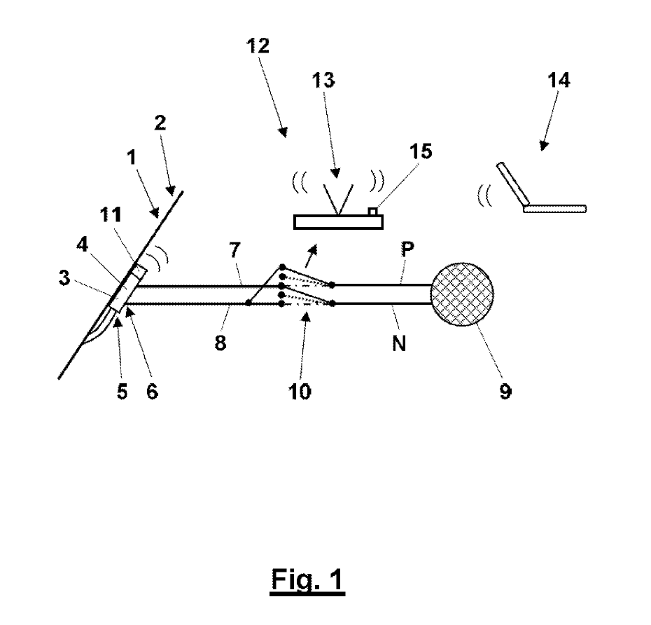

FIG. 1 illustrates a micro-inverter 3, mounted directly on a photovoltaic module 1 as an example of a local energy source 2, as an example of an inverter 4 according to the disclosure. An input 5 of the inverter 4 has the local energy source 2 electrically connected to it. An output 6 of the inverter 4 has an AC mains 9 connected to it via power supply lines 7 and 8. In this case, the connecting lines 7 and 8 have a toggle switch 10 arranged in them that can be used to transpose the association of the connecting lines 7 and 8 with the neutral conductor N and the phase conductor P of the AC mains 9 and that can also be used to isolate the inverter 4 from the AC mains 9. This is depicted in FIG. 1 by means of various switch positions in the form of different line types. The micro-inverter 3 has neither a dedicated display apparatus nor a dedicated input apparatus. The only way of communicating with the micro-inverter 3 is via a communication interface 11. This communication interface 11 can be used by the micro-inverter 3 to incorporate itself into a wireless local area communication network 12 that moreover includes a network access point 13 in the form of what is known as a router and a terminal 14 in the form of a laptop. So that the wireless local area communication network 12 can be operated as a protected wireless local area communication network, it is necessary for the micro-inverter 3, before subsequently being able to be simply incorporated into the wireless local area communication network 12, to be integrated into the wireless local area communication network 12. To this end, the network access point 13 can be moved to an integration state using a pushbutton 15. Such a pushbutton is not provided on the micro-inverter 3 and/or is not readily accessible on account of installation of the photovoltaic module 1 on a house roof, for example. In order to move the micro-inverter 3, particularly its communication interface 11, to an integration state, the mains voltage of the AC mains 9, for example, after the AC mains 9, that has initially been cut off from the micro-inverter 3 and the output 6 of the micro-inverter 3 has been isolated from the AC mains for a prescribed time period and/or with a changed association between the power supply lines 7 and 8 and the neutral conductor N and the phase conductor P of the AC mains 9, is applied to the output 6 of the micro-inverter 3 again. The micro-inverter 3 records the further presence of the mains voltage and the changed association of the power supply lines 7 and 8 and interprets them as a signal to transfer its communication interface 11 to the integration state. When both the inverter 4 and the network access point 13 are in their integration state, the inverter 4 can join the wireless local area network 12 and store access data pertaining to the wireless local area communication network 12 for its future incorporation into the wireless local area communication network 12.

Instead of the toggle switch 10, the changed association between the power supply lines 7 and 8 and the neutral conductor N and the phase conductor P of the AC mains 9 can also be caused manually, i.e. by reconnection. Isolation of the inverter 4 from the AC mains 9 can also be caused by a circuit breaker—not depicted here—in the power supply lines 7 and 8. FIG. 1 depicts a single-phase inverter 4—in this case: a micro-inverter 3—by way of example, the output 6 of which is connected to the AC mains 9 via the phase conductor P and the neutral conductor N. The method according to the disclosure, and the inverter 4 according to the disclosure for performing the method, is not limited to a single-phase inverter 4, however. Rather, the method can also be used for a polyphase, particularly a three-phase, inverter 4 in conjunction with the three-phase AC mains 9. Provided with a suitable phase locked loop (PLL) means a polyphase inverter 4 is also capable, in principle, of detecting and appropriately interpreting a transposition of phase conductors of a polyphase AC mains 9 at its output 6.

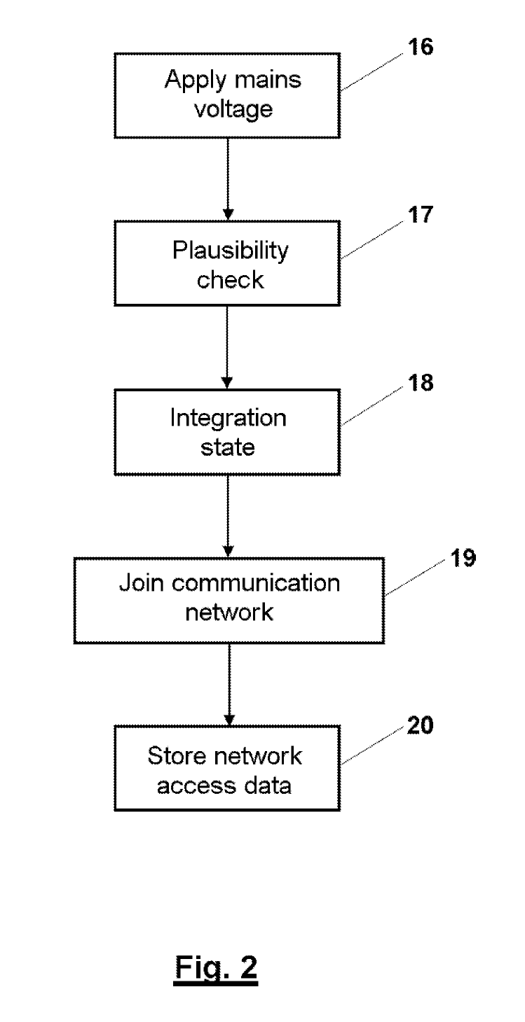

The flowchart shown in FIG. 2 illustrates various acts of the method according to the disclosure in order to move the inverter 4 to its integration state, and hence ultimately to integrate it into the wireless local area communication network 12, by applying the mains voltage of the AC mains 9. So that an application of the mains voltage performed initially at 16 does not unnecessarily result in the inverter 4 being transferred to its integration state, a plausibility check at 17 takes place first of all. FIG. 1 has been used to explain that this plausibility check can comprise the check to determine whether the association of the power supply lines 7 and 8 with the neutral conductor N and the phase conductor P of the AC mains 9 has been changed, with the applied mains voltage, in comparison with the mains voltage that was present earlier. In one embodiment a changed association between the power supply lines 7 and 8 and the neutral conductor N and the phase conductor P of the AC mains 9 results in the plausibility check at 17 being passed successfully and transfers the inverter 4 to its integration state at 18. An alternative or additional plausibility check checks whether the previous network access data still allow access to the wireless local area communication network 12. Only if this is not the case is the plausibility check deemed to have been passed successfully, and the inverter 4 is transferred to the integration state at 18. In addition, or as an alternative to those cited above, further plausibility checks at 17 are possible that prevent the inverter 4 from being unintentionally moved to the integration state. These plausibility checks can e.g. check whether the inverter is being connected to the AC mains 9 for the first time, and/or whether a time period during which the inverter 4 was isolated from the AC mains 9 prior to the application of the mains voltage in accordance with act 16 is consistent with a predefined time period taking predefined tolerances into consideration. Only after the one plausibility check at 17 or a plurality of envisaged plausibility checks at 17 has/have been passed successfully the inverter 4 is moved to its integration state at 18. If the network access point 13 is now also in its integration state, then the inverter 4 subsequently joins the wireless local area communication network 12 at 19. In this case, network access data are transmitted to the inverter 4. These network access data are stored in the inverter 4, i.e. specifically in a memory—not depicted separately here—associated with the inverter 4, in a subsequent act 20. These network access data can subsequently be used by the inverter 4 to repeatedly incorporate itself into the wireless local area communication network 12, for example after it has shut down at night without insolation onto the photovoltaic module 1. In a state in which the inverter is incorporated in the wireless local area communication network 12, there is access to the inverter 4, for example by means of the terminal 14 likewise incorporated into the wireless local area communication network 12.

What is claimed:

1. A method for integrating an inverter into a wireless local area communication network, wherein the inverter is connectable by its input to a local energy source and by its output to an AC mains, comprising:
taking the inverter and a network access point of the wireless local area communication network for a limited time period to an integration state in which the inverter joins the wireless local area communication network, wherein in the integration state, or thereafter, network access data pertaining to the wireless local area communication network are stored in a memory associated with the inverter;
subsequently using the stored network access data by the inverter to incorporate itself into the wireless local area communication network;
wherein the inverter is taken to its integration state by virtue of the mains voltage of the AC mains being applied to its output.

2. The method as claimed in claim 1, wherein the inverter is taken to its integration state when the mains voltage of the AC mains is applied to its output for the first time.

3. The method as claimed in claim 1, wherein the inverter is taken to its integration state when the mains voltage of the AC mains is applied to its output after its output has been isolated from the AC mains beforehand.

4. The method as claimed in claim 3, wherein the inverter is taken to its integration state when the mains voltage of the AC mains is applied to its output after its output has been isolated from the AC mains for a prescribed time period beforehand.

5. The method as claimed in claim 1, wherein the inverter is taken to its integration state when a mains voltage, between a neutral conductor (N) and a phase conductor (P) of the AC mains, is applied to two connections of the inverter output with a different association than there was beforehand.

6. The method as claimed in claim 1, wherein the inverter is taken to its integration state when a mains voltage of the AC mains is applied to its output, provided that it did not yet have a connection to the network access point in a current configuration thereof.

7. The method as claimed in claim 1, wherein the inverter is taken to its integration state when a mains voltage of the AC mains is applied to its output, provided that the inverter can no longer incorporate itself into the wireless local area communication network using the access data stored therein.

8. The method as claimed in claim 1, further comprising admitting the inverter to the wireless local area communication network only when there is an identification associated with the inverter in the network access point.

9. The method as claimed in claim 1, wherein the wireless local area communication network is a wireless local area communication network based on a WLAN standard.

10. The method as claimed in claim 1, wherein the integration state is a PBC configuration based on a WPS standard.

11. An inverter, comprising:
an input configured to connect the inverter to a local energy source,
an output configured to connect the inverter to an AC mains,
a communication interface configured to communicate in a wireless local area communication network,
wherein the communication interface is configured to be taken for a limited time period to an integration state in which the inverter joins the wireless local area communication network via a network access point, which is likewise in the integration state, of the wireless local area communication network, wherein network access data pertaining to the wireless local area communication network, which network access data are used by the communication interface to incorporate itself into the wireless local area communication network in the future, are stored in a memory associated with the inverter,
wherein the communication interface is configured to:
subsequently use the stored network access data by the inverter to incorporate itself into the wireless local area communication network;
wherein the inverter is taken to its integration state by virtue of the mains voltage of the AC mains being applied to its output.

12. The inverter as claimed in claim 11, wherein the communication interface is the exclusive interface for communication with the inverter externally.

13. The inverter as claimed in claim 11, wherein the inverter covers its own requirements for electric power at least primarily from the local energy source.

14. The inverter as claimed in claim 11, wherein the inverter is a micro-inverter.

15. The inverter as claimed in claim 11, wherein the local energy source is a photovoltaic generator.
